(19) United States
(12) Patent Application Publication
(10) Pub. No.: US 2006/0036689 A1
(43) Pub. Date: Feb. 16, 2006

(54) Personal messaging proxy

(76) Inventors: John Buford, Lawrenceville, NJ (US); Mahfuzur Rahman, South Brunswick, NJ (US)

Correspondence Address: HARNESS, DICKEY & PIERCE, P.L.C., P.O. BOX 828, BLOOMFIELD HILLS, MI, 48303, US

(21) Appl. No.: 10/862,165

(22) Filed: Jun. 4, 2004

(51) Int. Cl. G06F 15/16

(52) U.S. Cl. 709/206

(57) ABSTRACT

The personal messaging proxy is deployed as a component in a messaging or instant messaging system. The proxy provides information processing and routing services not found in conventional messaging or instant messaging and presence systems. The proxy provides session mobility, parental control, message aggregation, redistribution and filtering. The proxy also maintains personal information profiles for different kinds of devices based on presence and messaging services.

### BACKGROUND OF THE INVENTION

The present invention relates generally to instant messaging. More particularly, the invention relates to a proxy system for instant messages that allows control over session mobility, content, message aggregation, redistribution and filtering, and personal information profiles.

Instant messaging has gained wide popularity today. Part of the allure is the convenience of being able to communicate with others where communication by telephone would be inappropriate or inconvenient and where communication by e-mail is too slow. Many cellular telephones are equipped with instant messaging capabilities and these telephones are rapidly creating a new form of human interaction.

### SUMMARY OF THE INVENTION

While instant messaging has many advantages, there is still considerable room for improvement. The present invention provides a personal messaging proxy system or proxy component that may be added to a messaging or instant message system. The personal messaging proxy provides a variety of services not found in conventional messaging or instant messaging and presence (IMP) systems. Among these services are session mobility, parental control, message aggregation/redistribution/filtering and personal information profiles for different kinds of devices based on presence and messaging services. The a personal messaging proxy improves upon existing instant messaging systems. The proxy provides a first information port adapted to receive information from at least one information source, and a second information port adapted to supply information to the instant messaging appliance of a user. The proxy is configured to manipulate the information received from said at least one information source in a variety of ways, and to provide the manipulated information to the user in the form of an instant message.

As will be more fully explained herein, the present invention makes it possible to support a variety of additional features in an instant messaging system. These features include:
Virtual IMP clients;
Bidirectional filtering of messages, subscriptions, groups and presence information;
Group chaining;
IMP session mobility;
Parental control;
A personal messaging proxy that can be configured for rules which implement user-configurable automatic behavior;
A personal messaging proxy that can be controlled by user actions through an interface or through an instant message.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention. For a more complete understanding of the invention, its objects and advantages, refer to the following specification and to the accompanying drawings.

### BRIEF DESCRIPTION OF THE DRAWINGS

The present invention will become more full understood from the detailed description and the accompanying drawings, wherein:

FIG. 1 is a block diagram illustrating an enterprise proxy for instant messaging and presence with group chaining;

FIG. 2 is a similar block diagram illustrating a home proxy for instant messaging and presence with group chaining;

FIG. 3 is a block diagram illustrating how parental control may be implemented using the proxy according to one aspect of the invention;

FIG. 4 is an object diagram illustrating a presently preferred personal proxy implementation.

### DETAILED DESCRIPTION OF THE PREFERRED EMBODIMENTS

The following description of the preferred embodiment(s) is merely exemplary in nature and is in no way intended to limit the invention, its application, or uses.

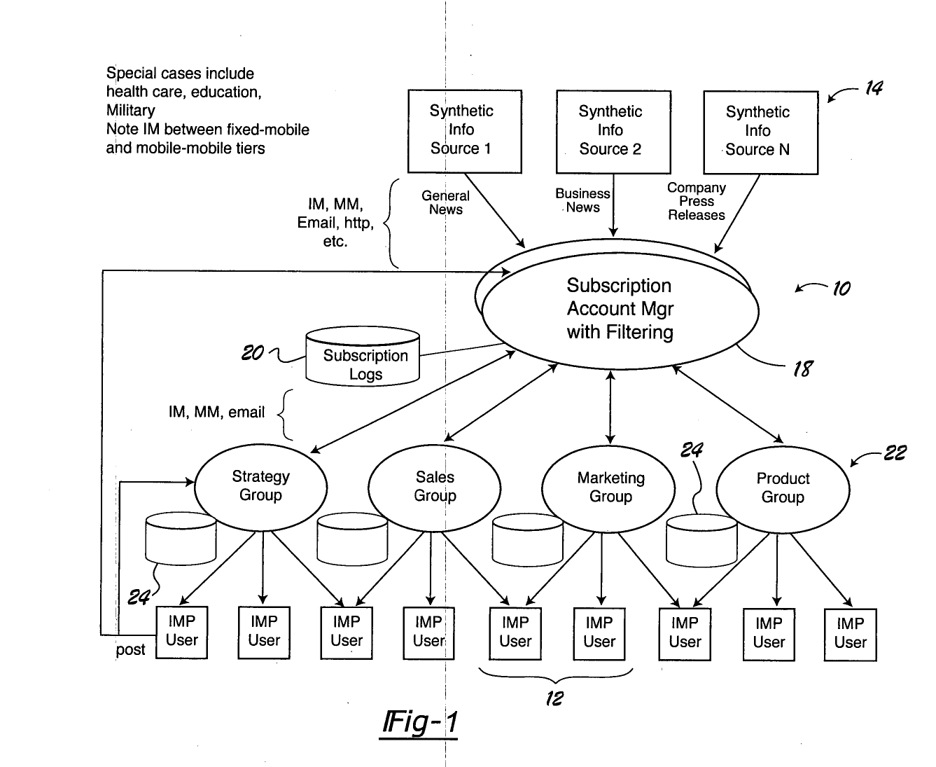

The personal messaging proxy allows a user to manage and configure instant messaging and presence services and to implement virtual instant messaging and presence devices in a unified way. As illustrated in FIG. 1, the proxy, shown generally at 10, is logically positioned as an intermediary between user client software and devices 12 and service provider relays and servers 14. The proxy may be implemented as a single software entity or a distributed software entity. It can be installed, for example, on a user's home computer, on a gateway, on an active server page (ASP), or in the service provider's network. Thus a collection of personal proxies for an arbitrary number of users could be implemented in one system.

In general, a person may have a number of devices and each of these devices may have different capabilities and resource constraints. The personal messaging proxy serves as a central resource to manage presence and instant messaging-related information. Examples of such information include, local contact list information, group information, message history for different kinds of devices, and the like. The personal messaging proxy can implement rules to match the incoming information with the capabilities of each of the user's devices. Thus, a user operating a very low end device may only receive basic presence and messaging information, formatted to fit the profiles for this particular low end device. Thus, for example, a contact list containing only the first ten entries might be displayed. In addition, further rules may be implemented to serve as information filters, effectively channeling selected information to predefine instant messaging and presence devices. The filtering operation can be performed in tiers to effect different information message chains, as illustrated in FIG. 1.

Referring to FIG. 1, the proxy 10 may be configured into one or more tiers (two tiers are illustrated here but a greater number is also possible). The upper level tier 18 operates as a subscription account manager with filtering. Information feeds from a plurality of different information sources (source 1, source 2, source N) are fed to the subscription account manager. The account manager then utilizes a stored subscription log 20 to filter the information and passes on to the intermediate tier 22. In the embodiment of FIG. 1, these intermediate tiers are configured to represent different groups within an enterprise. Each of the intermediate tiers has its own data store 24 where subscription logs are maintained for each of the intermediate tier groups. The intermediate tiers, in turn, filter the incoming information and pass it to the ultimate instant messaging and presence users operating their respective devices 12.

Note that the information flow among tiers and the instant messaging and presence users is bidirectional. Thus an instant messaging user can post a message to the intermediate tier group to which the user subscribes. The message posted is then filtered by the middle tier proxy and distributed accordingly, just as it would distribute any other received information. The middle tier proxy can, if required, route information to the upper tier 10, as illustrated. When the upper tier receives the information routed to it by the middle tier, it parses, filters and distributes that information using the same rules as it would apply to incoming information from the other information sources.

In a presently preferred embodiment, the intermediate tiers are designed to package information for delivery to the end users according to an instant messaging and presence protocol. Thus in this preferred embodiment, the information flow to the users and the information flow from the users to the higher level tiers is based on an instant messaging and presence protocol. It is possible, however, to configure the communication between upper tier and intermediate tiers to handle other protocols, such as e-mail and multimedia protocols. The proxy 10 is provided with parsing and semantic analysis capability whereby e-mail messages and multimedia messages are parsed and converted into instant messages for consumption by the user's devices 12. In the embodiment illustrated in FIG. 1, the upper level tier 10 is also able to parse and extract semantic content from webpages downloaded using the http protocol. It will be appreciated that the proxy 10 can be configured to receive information from essentially any information source, including but not limited to, instant messages, multimedia messages, e-mail, http information, FTP information, and the like.

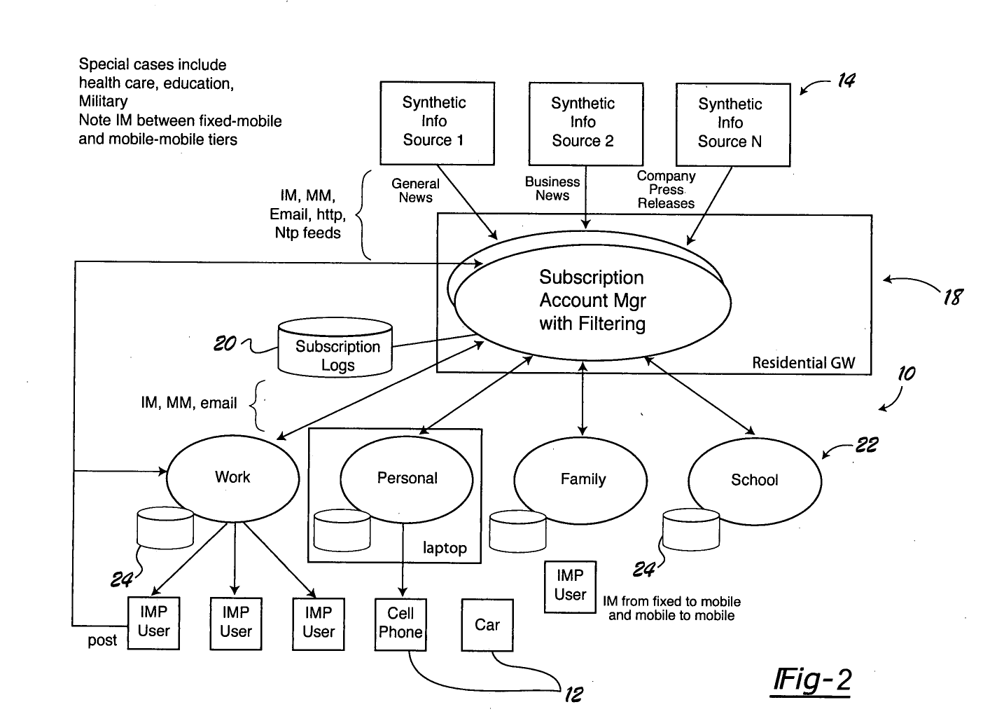

Before discussing further implementation details of the proxy, an additional example of the proxy will be discussed in connection with a home network application. In this embodiment the first tier 18 may be configured as a subscription manager with filtering that is deployed on a residential gateway computer. The intermediate tiers 22 may then be configured to represent different aspects of one's personal life (e.g., work, personal, family, school). The middle tier layer may also be implemented on the gateway system, or, if desired, one or more of the middle tier layers can be implemented on other personal computers or laptop computers. Thus, for example, a parent might elect to have his or her work or personal information stored on a personal laptop, while family information and school information might be stored on a networked computer that is accessible family wide. Message flow within the embodiment of FIG. 2 is essentially the same as that of the embodiment of FIG. 1.

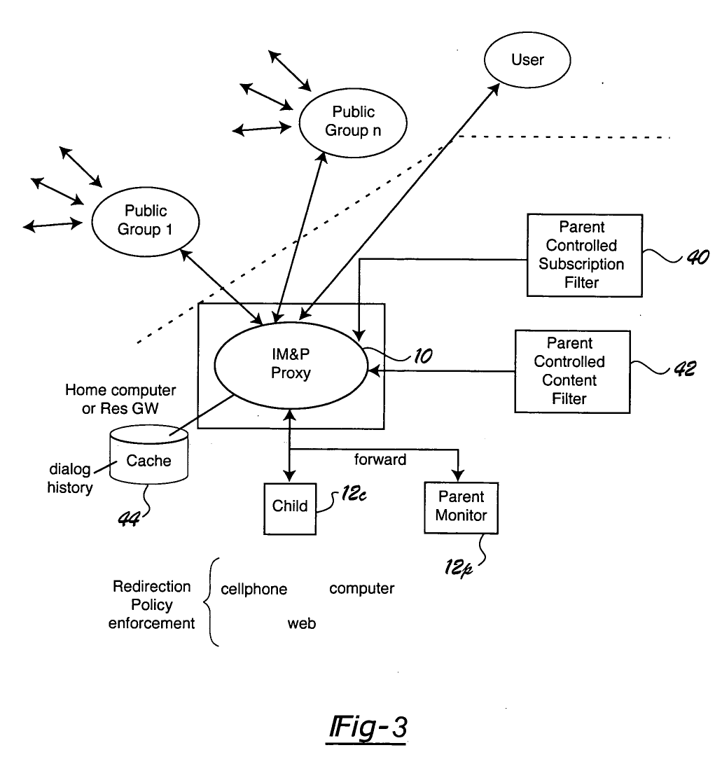

The personal messaging proxy 10 can give a user a high degree of control over information flow. This is in contrast to current instant messaging systems, which essentially act as simple message delivery conduits. To illustrate some of the power of the proxy concept, FIG. 3 shows how the personal messaging proxy can be implemented to effect parental control over instant messages. Instant messages have become quite popular among young people, and many parents are concerned that their children may be devoting too much time to instant message communication, or may be participating in inappropriate instant messaging.

To address this, the proxy 10 may be configured to contain a set of parent-controlled subscription filter rules 40 and also parental controlled content filter rules 42. Proxy 10 would then apply these filter rules when the child user 12c either wishes to subscribe to an information source or thereafter when the child participates in instant messaging sessions with other users. The instant messaging proxy 10 can be configured to forward all messages or selected messages to a monitoring parent's device 12p. In this way, a parent can periodically monitor the instant messaging behavior of the child. The parent could configure the system, for example, to forward selected instant messages to the parent's cell phone, or the system could be configured to generate a synthesized message based on messages between the child and other users or other information sources, with the synthesized message being forwarded to the parent. In addition, proxy 10 may have an associated data store or cache 44 that would store a dialogue history of the child's instant messages. The cache might be resident, for example, on a home computer or residential gateway, and could be accessed by the parent periodically to check for inappropriate instant messaging behavior.

### Additional Implementation Details of the Proxy

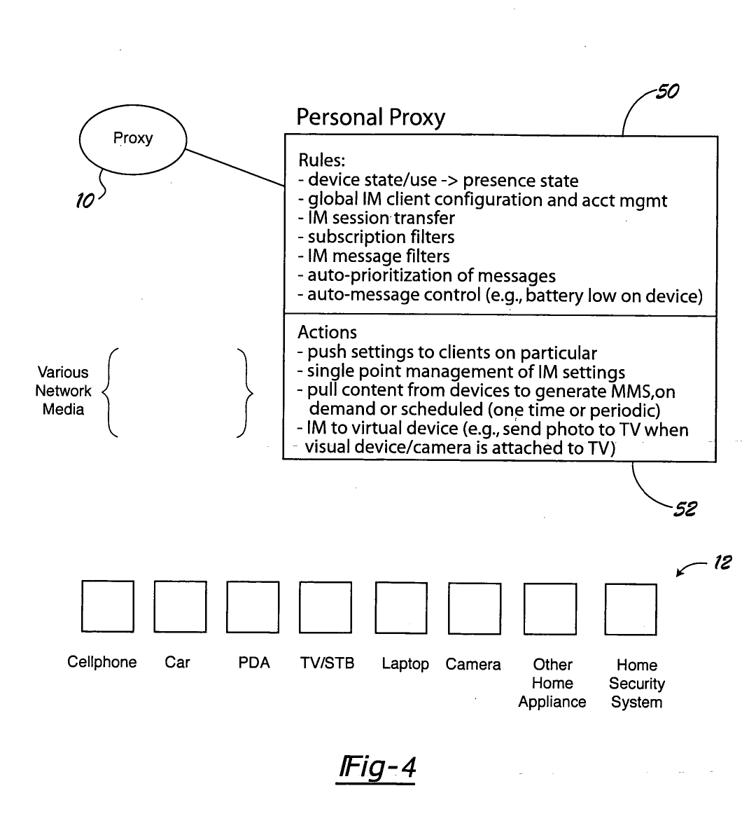

As illustrated in FIG. 4, the personal messaging proxy 10 may be viewed as a proxy object that mediates a predefined set of rules 50 and that is configured to perform a predefined set of actions 52. Examples of these rules and actions have been illustrated in FIG. 4. The proxy 10 may be configured to handle various different network media, thus allowing messages to be passed to and from a variety of different instant messaging and presence devices. Several examples of such devices have been Illustrated at 12 in FIG. 4.

### Service Rule Management

The user's preferences regarding messaging behavior across his or her set of communication and information devices can be viewed as rules which prescribe behavior given a set of conditions. The following table illustrates some rule categories as examples.

TABLE I

| Rule Category | Proxy uses rule(s) to . . . |
|---|---|
| Mapping of device | Translate user's device usage to |
| status/usage to | presence information (i.e., the |
| presence state | status of appliances/devices such |
| | as on, off, operational, etc.) of |
| | devices/appliances. |
| | The innovation will describe |
| | different presence attributes |
| | an appliance can have and also |
| | the retrieval procedure of this |
| | information. For example, the |
| | body of the SIP NOTIFY message can |
| | carry application specific presence |
| | attributes (i.e., device specific |
| | presence attributes such as: VCR: |
| | ON, OFF PLAYING, RECORDING, |
| | FAST_FORWARD, REWIND, etc. |
| Global IM client | Configure IMP client software on each |
| configuration | device and manage user attributes in |
| and acct mgmt | IMP service provider domains |
| IM session transfer | To enable/disable and control |
| | properties for IMP session transfer |
| | when user is in session on one device |
| | and switches to another device. |
| Subscription filter | Set filters on IMP group and user |
| | subscriptions which will cause un- |
| | permitted subscriptions to be blocked. |
| Message filters | Set content filters on IMP/SMS/MMS |
| | messages, which will cause unwanted |
| | content to be blocked. |
| | Set source filters on IMP/SMS/MMS |
| | message, which will cause messages |
| | from unwanted sources to be blocked |
| Auto-prioritization | Automatically determine SMS/MMS |
| of messages | message priority based on subject, |
| | recipient, or other attribute. |
| Auto-message | Determine scheduling and frequency |
| control | of messages that are automatically |
| | generated by devices for other |
| | devices or users. |

### Proxy Actions (Functions)

In general, the personal messaging proxy can be configured to provide a wide range of different information processing functions, ranging from simple information routing functions to more complex parsing and semantic processing functions. In the case of multimedia, the proxy might also include speech recognition capabilities, to allow human speech to be converted into text for subsequent information processing.

The following table lists some example functions that the personal messaging proxy can perform.

TABLE II

| Function | Notes |
|---|---|
| push settings to clients on each device used | |
| pull content from devices to generate MMS, | Virtual client send |
| on demand or scheduled (one time or periodic) | |
| IM to virtual device (e.g., send photo to TV | Virtual client receive |
| when visual device/camera is attached to TV) | |
| single point management of IM settings | |

In the past, when a person is participating in an instant messaging session, the person has been essentially locked into one device for that session. It is not heretofore been practical to switch from one device to another while continuing to participate in the session. The personal messaging proxy removes this limitation.

By referring to FIGS. 1 and 2, it will be seen that an instant messaging session flows to the end user device 12 through the proxy 10. by utilizing suitable routing rules, the information messaging session can be transferred from one device to another while the session is in progress. In addition to transferring the session from one device to another, the proxy 10 may also store the session history within a suitable data store or cache so that the session history can be transferred to the new device.

Proxy 10 can either replay the instant message from a stored log or it may simultaneously fork from the beginning of the session to each active device. The latter option would allow an instant message to be viewed on multiple devices concurrently. The proxy will keep history information of a messaging session and when the user is logged in with a different device, the history information at the proxy will be transferred to the new device, thereby providing a seamless messaging session. Also, based on the capabilities of the device, contact list, group information and other information may also be transferred to the new device.

In one presently preferred implementation, the transference of an instant messaging session from one device to another can be effected using the SIP/SIMPLE protocol, where a SIP REGISTER method is used to log in, with the proxy with a new device. The SIP PUBLISH method or MESSAGE method would then be used to transfer history or contact list and group information. A user defined header would be used to identify the kind of information contained in the body.

### Virtual IMP Clients and Virtual Devices

The personal messaging proxy may also be used to implement virtual instant messaging clients or virtual devices. In this regard, other devices could be remotely controlled to obtain information from which a message is generated or received on the device's behalf by the proxy. Referring to FIG. 4, a digital camera, for example, could have a locally stored photo, a battery level indicator, or its location in the home as stored state information. The personal messaging proxy could provide a virtual messaging client for the digital camera. This virtual client could receive messages from the user, such as “send me images 1 and 2,” “send me a list of images,” “send me your location in the house.” The messages are parsed and processed by the virtual client (using rules and actions of the proxy 10). The messages are then communicated to the device to perform the request. Note that the messages sent to a particular device would be translated into the operation semantics of the device.

In addition to allowing a user to send operating commands to a device, the personal messaging proxy can also be used to allow a device to send messages back to the user. As an example, the virtual client for the digital camera could be enabled to automatically send messages when a low battery indication or an image storage full indication are generated. The operating status of a device may be represented as device presence status information.

In a presently preferred embodiment, the presence status of a device can be configured using the SIP/SIMPLE protocol. The presence status would then be communicated between a user and the proxy using the SIP SUBSCRIPTION/NOTIFY method. When predefined states are detected on the device, the virtual client will automatically generate the associated message and send it to the user.

### Security Considerations

The personal messaging proxy can be used to authenticate a user accessing a device, such as accessing the digital camera in the example above. It is possible to directly authenticate a user with each device, however, the approach requires a potentially large number of secret keys and may be difficult to implement with devices that do not have sophisticated input terminals with which to enter the secret key. As an alternative, the authentication function may be relegated to a secure network with which the users authenticate. Upon authentication, the proxy would be invoked. Thus, in effect, users would authenticate themselves with the proxy and thereafter, the communication session would be assumed secure.

### Bidirectional Filtering and Group Chaining

As discussed in connection with FIGS. 1 and 2 the personal messaging proxy makes it possible to distribute messages according to tiers of message aggregation. Each tier has subscribers and filters. A collection of information sources sends messages to the first tier of groups. The messages are filtered and forwarded to the subscribers, which may represent a second tier of groups. The second tier collects and filters information from the first tier in order to satisfy requirements of the actual subscribers. These requirements might be based on priority, subject of message, message content, date, source, the active device the user is currently working with, or other attributes.

The description of the invention is merely exemplary in nature and, thus, variations that do not depart from the gist of the invention are intended to be within the scope of the invention. Such variations are not to be regarded as a departure from the spirit and scope of the invention. Accordingly, while the present invention has been described in its presently preferred embodiments, it will be understood that the invention is capable of modification without departing from the spirit of the invention as set forth in the appended claims.

What is claimed is:

1. In an instant messaging system, the improvement comprising:
a personal messaging proxy.
said proxy having a first information port adapted to receive information from at least one information source;
said proxy having a second information port adapted to supply information to the instant messaging appliance of a user;
said proxy being configured to manipulate the information received from said at least one information source and to provide said manipulated information to the user in the form of an instant message.

2. The system of claim 1 wherein said proxy is configured to define plural tiers, each tier representing different groups within an enterprise.

3. The system of claim 1 wherein said proxy is configured to define plural tiers, each tier representing different categories of information.

4. The system of claim 1 wherein said proxy performs filtering upon said received information.

5. The system of claim 1 wherein said proxy includes a subscription management component having a subscription log for storing information related to subscribers to services provided by the proxy.

6. The system of claim 1 wherein said proxy is configured to monitor instant messages and to notify a second user by instant message upon detecting predetermined conditions within the monitored instant messages.

7. The system of claim 6 wherein said second user is a parent and said predetermined conditions represent parental control rules.

8. The system of claim 1 wherein said proxy maintains a dialogue history of instant messages processed by said proxy.

9. The system of claim 1 wherein said proxy provides message monitoring services whereby instant messages to a first user are routed to a second user, allowing the second user to monitor the instant messages to the first user.

10. The system of claim 1 wherein said proxy is configured to parse received information based on predefined rules and to selectively route the received information as instant messages to selected ones of multiple users based on said rules.

11. The system of claim 10 wherein said predefined rules include a subscription mechanism whereby said users subscribe to receive selected information as instant messages.

12. The system of claim 1 wherein said proxy is configured to map the device status of an instant message appliance to a presence state attribute.

13. The system of claim 1 wherein said proxy is configured to automatically prioritize instant messages based on a predefined set of rules.

14. The system of claim 1 wherein said proxy is configured to automatically determine scheduling of automatically generated instant messages.

15. The system of claim 1 wherein said proxy is configured to push settings onto instant messaging appliances to thereby control the operation of said appliances.

16. The system of claim 1 wherein said proxy is configured to pull content from information sources based on predefined rules.

17. The system of claim 1 wherein said proxy is configured to transfer an active instant messaging session from one instant messaging appliance to another.

18. The system of claim 1 wherein said proxy is deployed as an intermediary between user client software and a service provider.

19. The system of claim 1 wherein said proxy is deployed as a distributed entity across plural computer systems.

20. The system of claim 1 wherein said proxy is configured to synthesize instant messages by combining information from plural information sources.
